(19) United States
(12) Patent Application Publication
(10) Pub. No.: US 2009/0216636 A1
(43) Pub. Date: Aug. 27, 2009

(54) Method of Promotion and Advertisement of a Website

(76) Inventor: James Eliason, Urbandale, IA (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/241,025

(22) Filed: Sep. 29, 2008

Related U.S. Application Data
(60) Provisional application No. 60/995,876, filed on Sep. 28, 2007.

(51) Int. Cl. G06Q 30/00

(52) U.S. Cl. 705/14

(57) ABSTRACT

A method for providing a video sharing website to be created, wherein members are able to upload, share, and view video clips is presented. In addition to providing members with the rights and control to the advertising space associated with their video clips, these members are able to use the advertising space to advertise their services and/or goods or to sell the available space for potential profit. This is a method for providing content providers with the option to profit from their content uploads.

This application claims priority to U.S. Patent Application No. 60/995,876 and incorporates U.S. Patent Application No. 60/995,876 herein by reference.

### BACKGROUND OF THE INVENTION

1. Field of the Invention

The present invention relates in general to a method of promotion and advertisement on a website. In particular, the present invention relates to a method for deriving revenue from advertising space appearing on a website.

2. Background

The Internet is a well-known medium for delivery of a nearly endless variety of information, including the promotion and sales of goods and services, in stored electronic form. Virtually all businesses utilize the Internet in one form or another for this purpose, which allows them to reach a potentially large audience. In fact, for a growing number of businesses, the Internet is the main medium by which they deliver both goods and services. In conjunction with the growth of the Internet based commerce, there has been a similar proliferation of techniques and technology designed to generate revenue through the advertising and promotion of goods and services on websites of others. Google, for example, has developed a number of these programs.

Google, while providing Internet search engine services, has also has created a revenue generating advertising module, known as AdWords. AdWords offers pay-per-click (PPC) and site-targeted advertising for both text and banner style advertisements. Pay-per-click is an advertising technique wherein advertisers bid on words they believe their “target market” will likely type in the search bar when looking for a specific product or service. When potential customers type a set of keywords into the search bar, advertisements will then pop-up to the side of the search results as brief, text-based one-line sentences. These ads are called “sponsored links.” Advertisers specify the maximum amount they are willing to pay each time a potential customer clicks the link to their advertisement. The cost usually varies between $0.01 per click to $0.50 per click and the advertiser only pays when someone clicks on the link. The order of paid listings depends on the amount advertisers bid and the quality score for all of the ads in a given search. A quality score is determined by a keyword's clickthrough rate (CTR) on Google, along with the relevance of the ad text, keyword, and landing page.

A banner advertisement is a form of pay-per-click online advertising that embeds an advertisement onto a webpage. Web banner advertisements employ images, animation, and/or sound, which is intended to increase traffic to an advertiser's website by linking potential customers directly to the website advertised in the banner when it is clicked on. An issue with this type of advertising is that individual advertisers must select their own keywords and determine the criteria to be used in the search. Advertisers are then left to hope they selected the correct keywords so their advertisements actually reach their target audience. This can be tricky, especially since word choices are often subjective and arbitrary. This can be especially problematic for local or smaller advertisers.

Google also offers site-targeted advertising, wherein advertisers enter their choice keywords of interest and then Google places those ads onto sites they consider relevant within their content network. Revenue is generated on a “cost per mille” basis for this service. An ongoing issue with this site-targeted advertising is, though advertisers are able to request sites where they do not want their ads to appear, they are not able to obtain a list of sites where their ads can and do appear.

YouTube is a popular video hosting service, which allows users to upload videos to an Internet website. This allows videos to be shared with others and then rated. These ratings, including the number of times the video has been watched, is published alongside the video. YouTube provides a wide variety of video content on their site, from movie and television clips to amateur videos and video blogging. Based on keywords and tags, links to related videos are placed to the right of the main video. Unregistered users can access and watch most of the videos and registered users have the ability to access and upload an unlimited number of videos.

At one time YouTube was using Google's AdWords for their advertising, but have since stopped. Now advertisers are able to purchase a banner ad on YouTube's homepage for $175,000 per day and prices vary for advertising space on other pages. One problem with YouTube's advertising revenue module is that YouTube makes significant money from user's videos, but the user does not earn any money from uploading a video to YouTube. Any material users upload onto YouTube is automatically licensed to YouTube, who then can use it for whatever purpose they see fit, including generating revenue.

For the foregoing reasons, there is a need for an online advertising system which allows content-based video uploaders to make profitable use of the material they upload, if they choose to do so, rather than just giving the material and all potential revenues to the video-sharing online service providers. Also, advertisers should be given the opportunity to pick and choose where they want their advertisements to be placed. Individuals and online advertisers should control their own content and its profit potential, as well as the space where it is to be placed.

Furthermore, while much improvement and advancement has taken place in the field of developing Internet based advertising methods and models, and the field of the delivery of text, graphic, and video content through the Internet, there exists a need to better combine the two fields in a novel manner to deliver a shared or distributed financial benefit to users, web site proprietors, content providers, and advertisers.

### SUMMARY OF THE INVENTION

The present invention is directed to the method that satisfies this need of giving individuals who upload material on video-sharing websites control of the potential revenues and financial benefits associated with the material they place on the Internet. The present invention combines advertising banners and content-based Internet sites in a novel manner. The invention relates to a method for allowing users desiring to upload video content onto a website the opportunity to purchase the banner space associated with that video. A user or potential advertiser can then choose to advertise in that space, immediately sell it, or hold on to it in anticipation of an increase in value. This gives the content provider initial control of the space surrounding their uploaded video material. In turn, this allows advertisers to pick and choose the videos their advertisement will be associated with and, in some instances, the amount to be paid for that space, thereby increasing their chances of reaching their target audience.

Accordingly, it is an embodiment of the present invention to present a method for providing an online user created content site in which content providers and advertisers are given space to upload video content, as well as the advertising banner spaces associated with the uploaded material. In one embodiment, the ad space initially belongs to the content provider unless or until it is sold by the content provider to a third party.

A further object of this invention provides a method for allowing a content provider to retain the advertising space for their own personal advertising use or to sell all or less than all of their allotted advertising spaces at any given time, in order to recoup their initial membership fees or as an investment opportunity to be bought out in the future where they may make a return on their initial investment, wherein the service provider will help to market the available banner space for sale.

A further object of this invention provides a method for allowing content providers to promote, share, and distribute their material, as well as choose to profit from any revenue generated from the advertisements placed in the advertisement space associated with their video clips, wherein the content provider is allowed to enter any HTML code allowing potential customers to link to other websites as they wish, while further offering a flagging mechanism which will serves as a means for reporting questionable material to the server provider.

A further object of this invention provides a method allowing the website service provider to generate revenues through paid monthly membership fees and transactional fees to be paid whenever an advertising space transfer occurs, wherein every single transaction that takes place the service provider will generate revenues.

A further object of this invention provides a method, which allows advertisers to pick the markets where they wish to advertise, as well as choose the price they wish to pay for the advertising.

According to another embodiment of the present invention, a method for calculating the value of the advertising space is determined on a per view calculation (PVC), which is the cost of the banner space divided by the number of page views, wherein advertisers can only purchase previously purchased space if the PVC is greater than the previous PVC sale.

Still other embodiments of the invention will become readily apparent to those skilled in the art upon reference to the following detailed specification, drawings, and claims. The invention is capable of different embodiments without departing from the spirit and scope of the invention.

### BRIEF DESCRIPTION OF THE DRAWINGS

FIG. 1 shows a functional block diagram illustrating a method for the promotion and advertisement of a website in one embodiment of the present invention.

FIG. 2 is a screen shot showing, by way of example, a webpage providing the promotion and advertisement of a website in one embodiment of the present invention.

FIG. 3 (a) is a block diagram showing the set-up of the user video and banner advertising space sold to content providers, in accordance with the present invention.

FIG. 3 (b) is a block diagram showing a takeover in the second tier when a banner advertising space sells to a third party advertiser in the present invention.

FIG. 3 (c) is a block diagram showing the takeover in a third tier when a banner advertising space sells in the present invention.

FIG. 3 (d) is a block diagram showing the takeover when a member content provider retains possession of at least one banner advertising space in the present invention.

FIG. 3 (e) is a block diagram showing the takeover when a content provider chooses to transfer each banner advertising space separately in the present invention.

FIG. 4 is a block diagram showing the banner advertising space and the links for purchasing or reporting the banner advertising space in another embodiment of the present invention.

FIG. 5 is a block diagram showing on embodiment of the revenue sharing model of the present invention.

### DETAILED DESCRIPTION

Method Overview

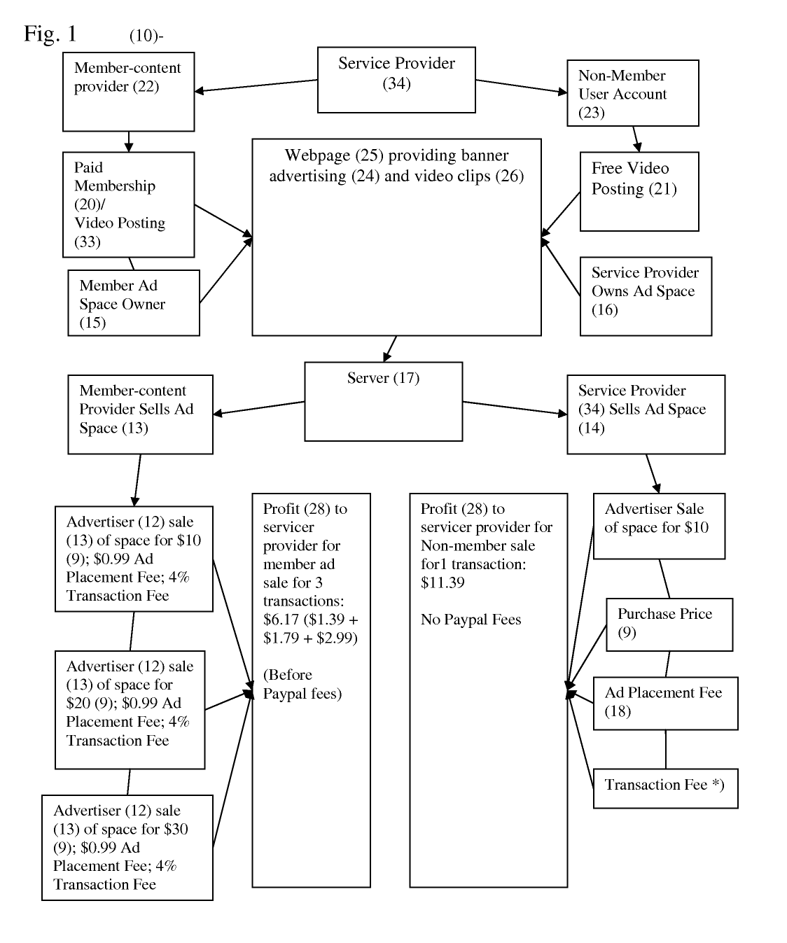

As shown generally in FIG. 1, the present invention is a method of generating revenue for a website content provider, as well as for a service provider through the sale of webpage space. A content provider 22 uploads content to a webpage, wherein the webpage is provided to the content provider 22 by a service provider 34. The webpage allows both user content (such as videos) and advertisements to be uploaded and displayed. Videos are typically used as examples, but the invention is not limited to video content. The content provider 22 may fill the advertisement space with the content provider's 22 own advertisements, or the content provider 22 may sell the advertisement space to other advertisers. There are several different embodiments for how the advertisement space is sold and for what price. For example, the administrator of the website may set the price for advertisement space, the content provider may set an initial price for the advertisement space, or an auction system or other standardized calculation may determine the price of the space. Most typically, the service provider or administrator sets the price for advertisement space, taking into account market factors, and the number of viewings that a particular webpage has received.

The content provider 22 may elect to place his or her own advertisements in the advertisement space around the content provider's content. These advertisements may include links to other pages, such as the provider's 22 social networking pages (like MySpace, Facebook, Twitter, LinkedIn), eBay pages where the provider 22 or others are selling items, or business websites.

There are at least possible revenue streams derived from the uploaded content. The first revenue stream is if the content provider buys the advertisement space or spot for a set price. The second stream is if there is no purchase by the content provider, the service provider will insert click-through revenue ads. Finally, if the space is not purchased by the content provider, the advertisement space may enter the market for advertisers to buy, and a portion of the money collected from the sale to advertisers is kept by the service provider, while the remainder is distributed to the content provider.

In the auction example described in detail below, the previous advertiser also retains a share of the purchase price of the advertisement. So, the service provider, content provider, and prior advertiser all earn money from the sale of the advertisement space.

Further, advertisers are given the ability to search and advertise locally and users or viewers of the service can view content from local providers and connect with users socially and in a marketplace. Advertisers are also given the ability to search the service provider's webpages for targeted content to aid in selecting individual webpages that are most suited for the advertiser's products or services.

FIG. 1 is a functional block diagram showing a novel method for the promotion and advertisement of a website 10, providing for a content-based internet site wherein ad space rights are assigned to members upon payment of a membership fee. A service provider 34 is responsible for building webpages 25, which provide spaces for video clips from user videos 26 and banner advertising spaces 24, as well as an information box 19 giving details about the video 26. The information box 19 also provides links 28 to purchase the banner ad spaces 24 and information about service provider 34. The service provider 34 controls the contents, details, and links 28 in the information box 19.

In one embodiment, there are different types of accounts that may be set up under the service provider 34, including a paid membership account 20 and a free non-member user account 23. The free non-member user account 23 allows for free registration of non-member video uploading 21 via a server 17 hosted by the service provider 34. If the free non-member user account 23 is chosen to upload a non-member's video 21 onto a webpage 25, a user will register with the service provider 34. The non-member user 23 then grants license to the service provider 34 to distribute and modify the non-member's video 21 until it is deleted. In this situation, the service provider 34 is the owner 16 of the banner ad space 24 associated with the user video 26. If the service provider 34 makes an ad space sale 14 to an advertiser 12 interested in advertising on the banner space 24, then any realized profits from the sale 28 belong to the service provider 34. When the service provider 34 sells the banner ad space 24, an advertiser 12 then pays an agreed purchase price 9 for rights to the banner ad space 24 plus an ad placement fee 18 and a transaction fee 8, all of which result in revenue 28 for the service provider 34.

In another embodiment, the account 20 (in most instances a paid membership account, but the account is not limited to this) or service provider 34, grants member content providers 22 with exclusive rights to the webpage 25 containing their user video 26, including member video uploads 33 to be shown as their user video 26. The member content provider 22 also becomes an ad space owner 15 of the banner ad space 24 associated with their user video 26. The service provider 34 maintains control over the content in the information box 19. A user becomes a member content provider 22 by paying a monthly fee 34 in order to have a paid membership 20 and to retain control of the webpage 25 including the banner ad space 24. A user may also become an eligible content provider 22 by meeting a threshold level of videos uploaded in the past, or if other videos uploaded by that user were viewed a certain number of times. In this way, a content provider 22 may be given access to advertisement space and revenues derived from advertisements without paying a fee to the service provider 34.

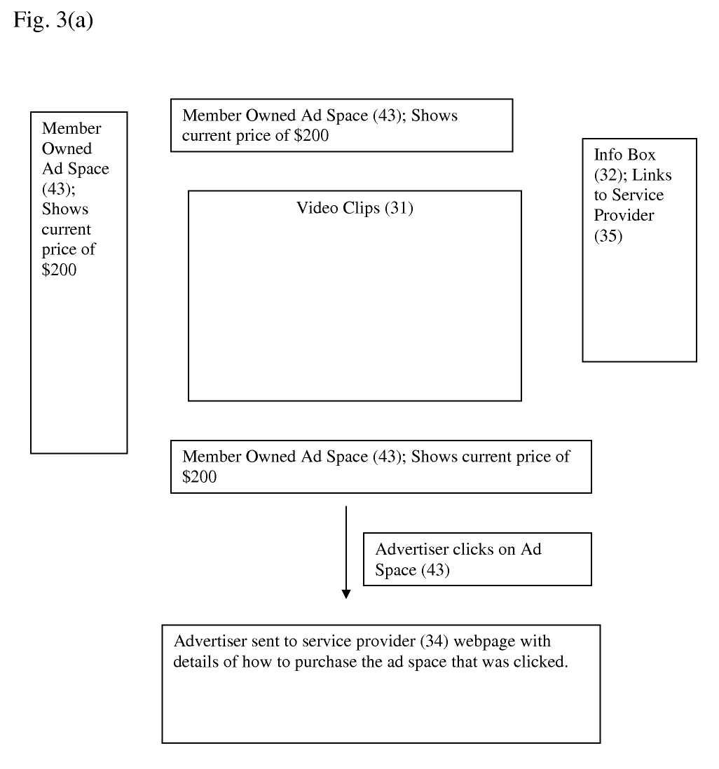

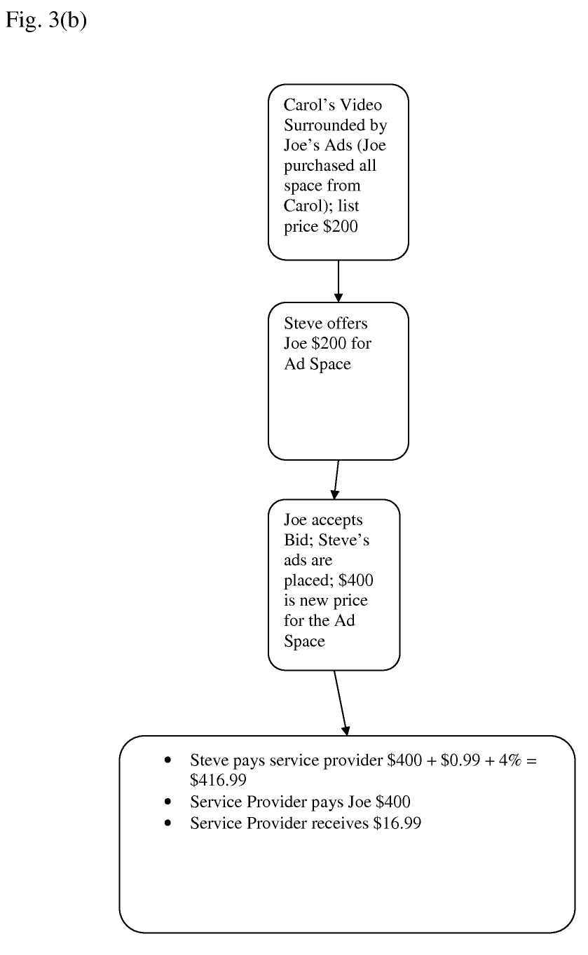

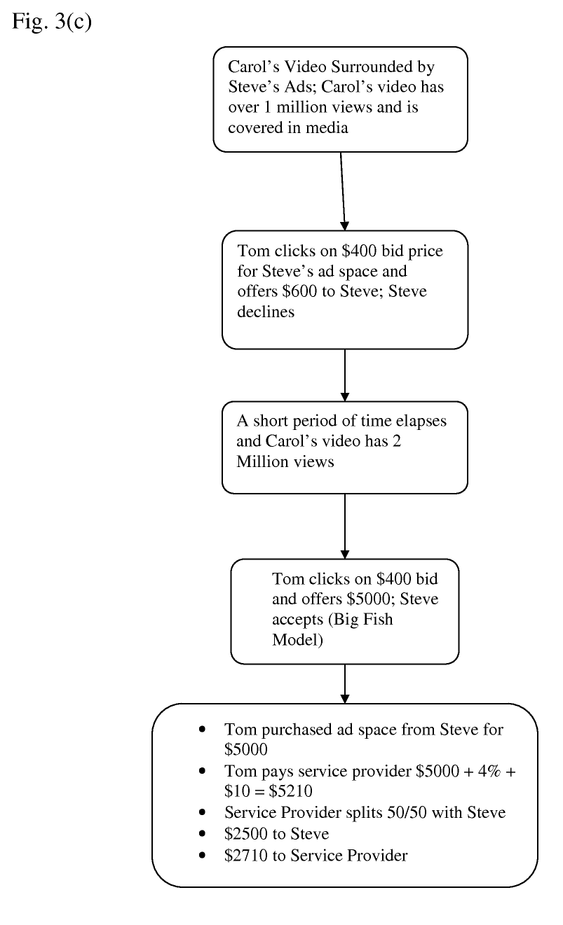

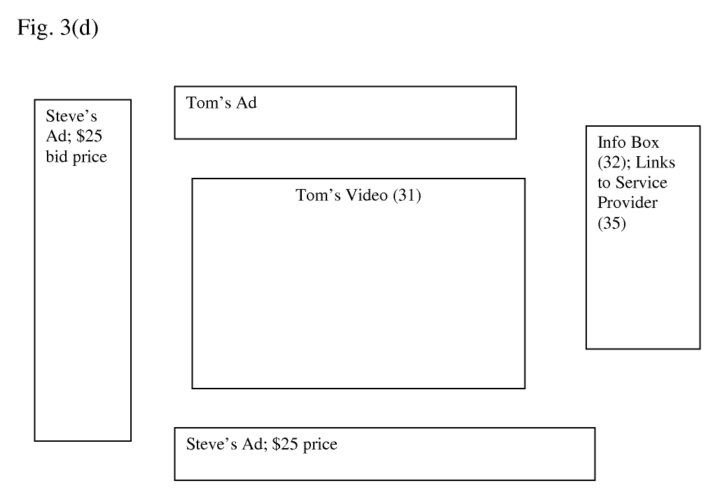

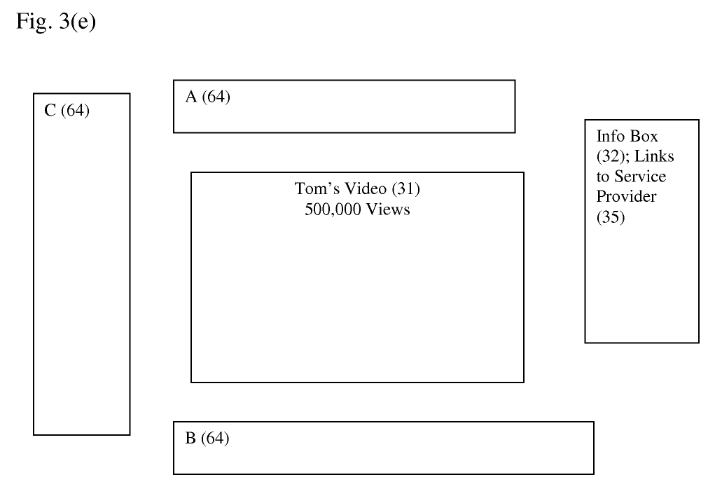

The member content provider 22 then has the right to upload and/or delete any material they wish from both the user video section 26 of the webpage 25 and/or the banner ad space 24. Furthermore, the member content provider 22 is able to place any material they see fit into the banner ad space 24 allotted to them with their paid membership 20, since the member content provider 22 has control of and is the ad space owner 15 of the banner ad space 24. Potential users of this kind of promotion and advertisement website 10 may include, but are not limited to: small or local businesses that process orders and/or provide services; advertising agencies looking for a less expensive, more expansive option to advertise; political interest groups desiring to convey their points of view; and investors hoping to be bought out in the future for a profit. After obtaining the paid membership 20, the member content provider 22 may choose to sell the ad space 13 to an advertiser 11, as further described below beginning with FIG. 3(a).

When the member content provider 22 sells their banner ad space 24, an advertiser 12 then pays an agreed purchase price 9 for the member content provider's 22 rights to the banner ad space 24. In addition to the purchase price 7, an advertiser may pay an ad placement fee 18, plus a transaction fee 8. The agreed upon purchase price 7 is paid to the member content provider 22, while the ad placement fee 18 and the transaction fee 8 results in revenue 28 for the service provider 34.

In another embodiment of the present invention, a model determines the value of the banner space . The model is based on a “per view calculation”, which is the cost of the banner space divided by the number of page views . An advertiser pays for the banner ad space based on points to be determined by the per view calculation model . The higher the points, the higher the purchase price will be. In this embodiment, if the banner ad space is member owned 15, then the member content provider 22 and the service provider 34 split the profits in an 80/20 split, 80 percent of the purchase price going to the member content provider 22 and 20 percent of the revenue amount going to the service provider 34. In addition to the 20 percent being received by the service provider 34, an ad placement fee 18 and the transaction fee 8.

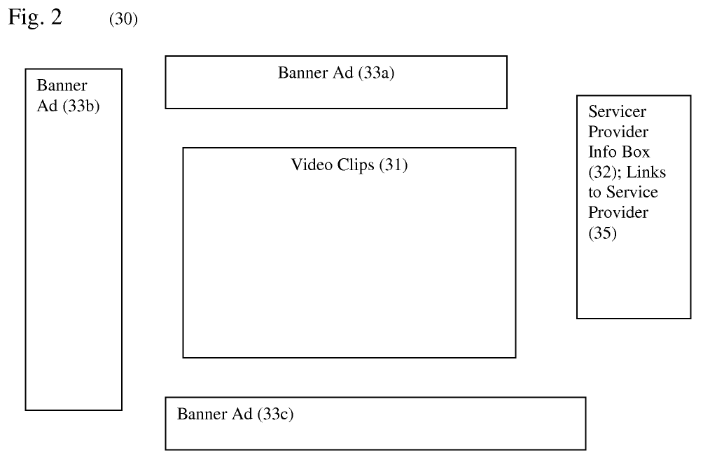

FIG. 2, in one embodiment of the present invention, is a screen shot of the webpage 30 showing, by way of example, the webpage providing a space for the video user 31, along with a number of banner advertising spaces 33. An information box 32 is provided, which contains information pertaining to the user video 31. The information box also contains links 35, which may be clicked on to find out more about becoming a member 22, the service provider 34, and purchasing the banner advertising space 33. In the user video clip space 31 located on the webpage 30, member content providers 22 and non-members with a free account 23 are able to upload the video material of their choice. In the banner advertising space 33 associated with the user video clip 31, a member content provider 22 or an advertiser 11 can place their advertisement and provide a hyperlink to another website where their information, goods, and/or services can be viewed.

Method Overview

FIGS. 3(a)-3(e) are block diagrams showing, by way of example, the set-up and subsequent takeovers that may occur when the banner advertising spaces, also know as “RAS” (Revenue Ad Spot) or advertisement space/spots 24 change ownership, according to an embodiment of the invention. Referring first to FIG. 3(a), in one embodiment, a screen shot 40 illustrating an example of a set-up of the webpage 25 when a member content provider 22 owns both the user video space 46 and all of the banner advertising space 43 associated with the user's video 46. In this described embodiment, the information box 43 provides information about the video and links 45 which will give information about advertising with the service provider 34, signing up for a paid membership 20, becoming a registered user 7, and obtaining banner advertising space 43. Also, in the described embodiment, there is a small link 44 next to each banner advertising space 43 with the current purchase price for the space 44. Clicking on one of these links 44 next to banner ad space 43 will take potential advertisers 12 or users 7 through a series of steps which allows them to purchase the particular banner advertising space 43 next to the particular link 44 the potential advertiser clicked on. If the advertiser 12 agrees to the purchase price 9 and a sale takes place, the member content provider 22 will receive the full amount of the purchase price 9 and the service provider 34 will receive both an ad placement fee 18 and a transaction fee 8. In a further embodiment, when the sale of banner ad space 13 occurs, who ever owns that space 24 can elect to sell all or some of their ad space 24 to another party advertiser 12.

Referring next to FIG. 3(b), screen shot 40 depicts a takeover in the second tier when a banner ad space 43 transfers to a third party advertiser. In the described embodiment, the member content provider 22 has sold his/her rights to the banner ad space 44 to another user 7. The user 7, in turn, sells his/her space to a third party advertiser 11 for a profit. The service provider 34 then makes a profit 28 from the sale in the form of an ad placement fee 18 and a transaction fee 8. The member content provider 22 maintains control of the user video 46 and a third party advertiser 11 purchases rights to the banner advertising spaces 43 associated with the member content provider's 22 user video 46. The third party advertiser 11 is then able to place advertising material of their choice in the banner advertising spaces 41. Furthermore, the third party advertiser 11 is able to change the advertising space purchase price links 44 to reflect the amount desired should someone else be interested in purchasing the banner advertising space 41. An example of this embodiment is as follows as referenced in FIG. 3(b):
a) Joe has purchased all three of the banner ad spaces associated with Carol's video;
b) Joe advertises sale of all three banner ad spaces for $400 ($133.33 a piece);
c) Steve purchases all three of the banner ad spaces from Joe for the $400 asking price;
d) Steve pays the service provider the $400 purchase price plus a $0.99 ad placement fee plus a four percent transaction fee for a total of $416.99;
e) the service provider pays Joe the $400 purchase price;
f) the service provider makes a net profit of $16.99 from the deal; and
g) Carol receives no additional funds from the sale since she previously sold her rights to all of banner ad spaces.
   It is well known to those of ordinary skill in the art that the fees will vary without departing from the spirit and scope of the invention, and the various fees can be zero.

Referring next to FIG. 3(c), a screen shot 40 showing a takeover in the third tier when the banner advertising space 43 transfers to a fourth party advertiser 45 and the purchase price 9 for the space 43 is over a certain figure. The member content provider 22 still maintains control of the user video 46 and a fourth party advertiser 45 purchases the banner ad spaces 43 from the third party advertiser 11 (as shown in FIG. 3(b)). In this embodiment of the present invention, if the purchase price 9 is over a certain predetermined amount, the profit 28 will be split between the current advertiser 12 and the service provider 34 in a 50/50 split. The fourth party advertiser 45 is then able to place advertising material of their choice into the banner ad spaces 41. The fourth party advertiser 45 also has control of the advertising purchase price link 44 and may place an amount desired for a possible resale for the banner advertising space 43. An example of this embodiment as built upon the previous example in FIG. 3(b), as referenced in FIG. 3(c) is as follows:
a) Steve advertises sale of all three banner ad spaces for $5000 ($1666.66 a piece);
b) Tom purchases banner ad space from Steve for the $5000 asking price;
c) Tom pays the service provider the $5000 purchase price plus a $10 ad placement fee plus a four percent transaction fee for a total of $5210;
d) the service provider splits the $5000 in a 50/50 split with Steve, since the purchase price was over $2500, wherein the service provider pays Steve $2500;
e) the service provider makes a net profit of $2720 from the deal which includes the ad placement fee and a four percent transaction fee; and
f) a caveat to this example exists if a member content provider, such as Carol, is in control of the ad space, then the split would be 80/20 (80 percent to the content provider and 20 percent to the service provider).

It is well known to those of ordinary skill in the art that the fees will vary without departing from the spirit and scope of the invention.

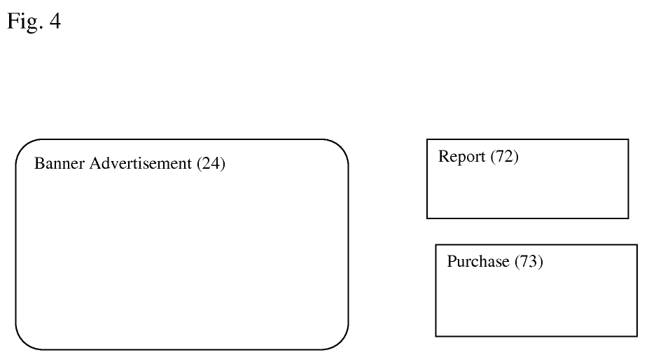

Referring next to FIG. 3(d), a screen shot 50 showing the takeover of a member content provider 22 retaining control of at least one banner ad space 52. In this embodiment of the present invention, the member content provider 22 uploads material into the user video 56 and also provides a hyperlink to information, goods, and/or services of their choice in at least one banner advertising space 52. The member content provider 22 also has the option of placing a purchase price 9 in the links 54 provided next to banner ad spaces 52. Any remaining banner ad spaces 55 may then be sold to third or fourth party advertisers (43, 45) who get to choose the content to be placed in those banner ad spaces 55, as well as the purchase price to be placed in the link 54 associated with their banner ad space 55. The member content provider 22 retains discretion of material uploaded into the user video 56 and the material to be shown in their banner ad space 52. As long as the member content provider 22 retains ownership of at least one of the banner ad spaces 52, that user 7 also retains discretion of the material that can be placed therein, but as soon as that banner ad space 55 is sold to an advertiser 12, all discretionary rights are lost, because those advertising rights are bought by and thereby transferred to the advertiser 12. If the member content provider 22 does not agree with the material placed in the purchased ad space 55, then they may report it to the service provider 34, as further described below in FIG. 4.

Referring finally to FIG. 3(e), a screen shot 60 depicting the takeover when a member content provider 22 chooses to transfer each banner ad space 64 separately. The member content provider 22 is able to transfer each banner ad space 64 one by one, at different points in time, for different purchase prices. This information is provided in the links 65 associated with each banner space 64. Regardless of how or when the banner spaces 64 are transferred, the member content provider 22 retains control of the material to be uploaded or deleted in the user video 66 and the service provider 34 retains control of content in the information box 63. Once the banner advertising space 65 is sold, the member content provider 22 looses their right to control the content of the material that can be placed therein. Note, according to one aspect of the invention, the member content provider 22 is advised to retain control of at least one banner advertising space 64 in order to retain the option of future revenue potentials.

Banner Transfers and Control

FIG. 4 is a block diagram 70 showing the banner advertising space 24 and the links 74 for purchasing and reporting the banner advertising space 24, in accordance with one embodiment of the present invention. After transfer of the banner advertising space 24, the content provider 22 no longer controls what material is to be placed in the space as they have transferred their right to control that space 24. If the content provider 22 disagrees with the content of the material placed by an advertiser 11 in the banner ad space 24, they are able to report it to the service provider 34 by clicking on a banner flagging link 72. The service provider 34 then has discretion to remove or allow the material in the banner advertising space 71, according to the terms of the membership agreement 20.

### Alternative Embodiment

In another embodiment, a specific formula is not employed to calculate the price of the advertisement space. The price is determined instead by the following process:

Step 1: Content provider uploads video onto the website.

Step 2: Content provider elects to pay a $0.99 minimum for access to the advertisement space. In this example, the Content provider purchases all four advertisement spaces around the uploaded video, so the content provider pays $3.96.

Step 3: Content provider builds their own banner ads for placement in the four advertisement spaces surrounding the video.

Step 4: A “Buy Now” button appears next to each banner for a minimum price set by the content provider. In this example the content provider sets the price at $4.50.

Step 5: An advertiser searches the videos appearing on the website for content matching their products. The advertiser identifies the content provider's video and is willing to pay $4.50.

Step 6: The transaction takes place and the advertiser's banners are placed surrounding the content.

Step 7: The “Buy Now” button now appears with a higher price, according to the calculation below.

Once the advertisement space has been purchased by an advertiser, the price for the banner is determined as follows. According to the following calculation, the first purchaser will receive 35% of the price paid back when then advertisement space is taken over by a new advertiser. In the example above, the first advertiser paid $4.50 for the advertisement space, and will be guaranteed $1.58 back should another advertiser purchase the advertisement space. There will be and 80/20 split on the second, third, fourth, etc. advertisement space sales. Consequently, in order for the first advertiser to receive $1.58 back, his or her 20% of the second advertisement space sale will need equal $1.58, so the advertisement space will be priced at $7.95.

A membership program for advertisers is also a component of the invention. Advertiser- members can automatically match advertisements to videos uploaded by content providers.

### Additional Embodiment

In another embodiment, if the content provider pays for the advertisement space (in one example, the content provider pays $0.99 per space), the content provider is guaranteed a certain number (in this example 1000) impressions on their advertisement, which also means 1000 views of the content provider's video. At view 1001, the service provider's default ads are inserted and the advertisement space is placed on the market for advertisers to purchase.

Similarly, the service provider may also guarantee to the advertiser a certain number of impressions on their advertisements. By way of example, if the video has 300,000 views and the advertiser buys advertisement space around that video for $100, the service provider will guarantee the advertiser 10,000 advertisement impressions.

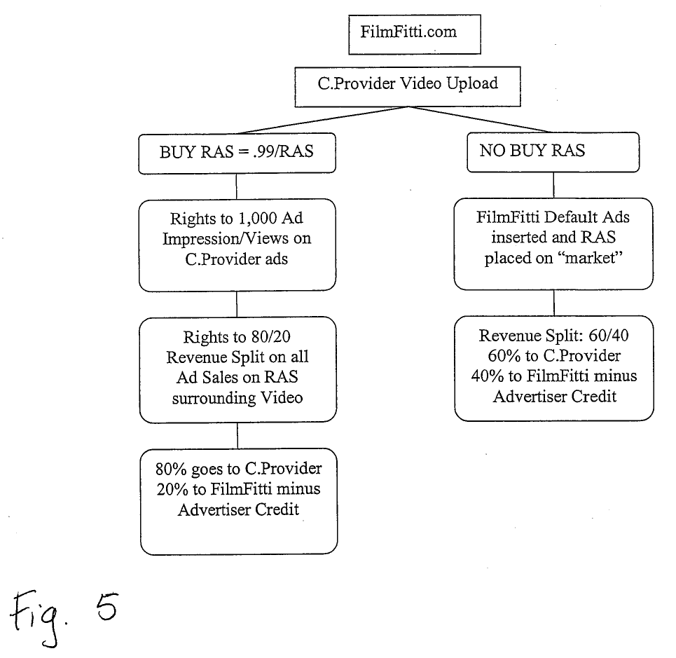

As shown in detail in Table 1 and FIG. 5, if a content provider decides to purchase each advertising spot for 0.99 cents, the service provider gives the content provider 2 things:
1) the rights to 1,000 impressions/or views on their Ads
2) the rights to a 80/20 Revenue split on all future ad sales

If a content provider doesn't buy any advertising spot from the service provider, the service provider inserts its default ads and place the advertising spot on the market for the Bulk Buy system or database for advertisers to purchase at a discount. The revenue is shared 60/40, 60% to Content provider, 40% to service provider.

As far as what the advertiser will receive, there are guaranteed ad impressions/or views on the advertiser's ads. The service provider sells a certain number of ad impressions next to a particular video for a minimum price. Then at checkout, the advertiser is able to purchase more impressions for a set cost. Advertisers will still receive 20% back on their investment if the RAS is bought by another advertiser after they receive the impressions they paid for.

In an additional system, the service provider will set the price for the advertiser's buy price based on market conditions. The service provider can also manually change the price and not rely on the program to do so.

Also, on a content provider's video presentation, the content provider could own any number of advertising spots on the content provider's page, from zero up to the total number of spots available. For example, if there are four advertising spots available and the content provider owns 1 spot, the other 3 are owned by the service provider and in the Revenue Share plan, the service provider does not give complete revenue share on all 4 if the user only buys 1 spot, for example.

The service provider may also offer a tool to help advertisers or content providers to build and develop advertisements. The tool also allows advertisers to insert click-through revenue HTML from Google and others.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention. For example, once a member buys their advertising space, they are free to resell it and make a profit in an online auction type of setting. Also, it is well known to those of ordinary skill in the art that the fees, percentages and other numbers or figures used by way of example will vary without departing from the spirit and scope of the invention.

TABLE 1

| | | | | | | |
|---|---|---|---|---|---|---|
| | Minimum | | Per Impression | Content Provider | Previous | FilmFitti |
| # of Views | Buy Price | Impressions | Cost | Revenue | Advertiser Credit | Revenue |

RAS 1

| | | | | | | |
|---|---|---|---|---|---|---|
| 0-1,000 | $0.99 | 1,000 | $0.0010 | $— | $— | $0.99 |
| 1,001-5,000 | $3.99 | 4,000 | $0.0010 | $3.19 | $— | $0.80 |
| 5,001-10,000 | $4.99 | 5,000 | $0.0010 | $3.99 | $0.80 | $0.20 |
| 10,001-20,000 | $9.99 | 10,000 | $0.0010 | $7.99 | $1.00 | $1.00 |
| 20,001-40,000 | $12.99 | 20,000 | $0.0006 | $10.39 | $2.00 | $0.60 |
| 40,001-60,000 | $15.99 | 20,000 | $0.0008 | $12.79 | $2.60 | $0.60 |
| 60,001-100,000 | $21.99 | 40,000 | $0.0005 | $17.59 | $3.20 | $1.20 |
| | $70.93 | | | $55.95 | $9.59 | $5.39 |

RAS 2

| | | | | | | |
|---|---|---|---|---|---|---|
| 0-1,000 | $0.99 | 1,000 | $0.0010 | $— | $— | $0.99 |
| 1,001-5,000 | $3.99 | 4,000 | $0.0010 | $3.19 | $— | $0.80 |
| 5,001-10,000 | $4.99 | 5,000 | $0.0010 | $3.99 | $0.80 | $0.20 |
| 10,001-20,000 | $9.99 | 10,000 | $0.0010 | $7.99 | $1.00 | $1.00 |
| 20,001-40,000 | $12.99 | 20,000 | $0.0006 | $10.39 | $2.00 | $0.60 |
| 40,001-60,000 | $15.99 | 20,000 | $0.0008 | $12.79 | $2.60 | $0.60 |
| 60,001-100,000 | $21.99 | 40,000 | $0.0005 | $17.59 | $3.20 | $1.20 |
| | $70.93 | | | $55.95 | $9.59 | $5.39 |

RAS 3

| | | | | | | |
|---|---|---|---|---|---|---|
| 0-1,000 | $0.99 | 1,000 | $0.0010 | $— | $— | $0.99 |
| 1,001-5,000 | $3.99 | 4,000 | $0.0010 | $3.19 | $— | $0.80 |
| 5,001-10,000 | $4.99 | 5,000 | $0.0010 | $3.99 | $0.80 | $0.20 |
| 10,001-20,000 | $9.99 | 10,000 | $0.0010 | $7.99 | $1.00 | $1.00 |
| 20,001-40,000 | $12.99 | 20,000 | $0.0006 | $10.39 | $2.00 | $0.60 |
| 40,001-60,000 | $15.99 | 20,000 | $0.0008 | $12.79 | $2.60 | $0.60 |
| 60,001-100,000 | $21.99 | 40,000 | $0.0005 | $17.59 | $3.20 | $1.20 |
| | $70.93 | | | $55.95 | $9.59 | $5.39 |

RAS 4

| | | | | | | |
|---|---|---|---|---|---|---|
| 0-1,000 | $0.99 | 1,000 | $0.0010 | $— | $— | $0.99 |
| 1,001-5,000 | $3.99 | 4,000 | $0.0010 | $3.19 | $— | $0.80 |
| 5,001-10,000 | $4.99 | 5,000 | $0.0010 | $3.99 | $0.80 | $0.20 |
| 10,001-20,000 | $9.99 | 10,000 | $0.0010 | $7.99 | $1.00 | $1.00 |
| 20,001-40,000 | $12.99 | 20,000 | $0.0006 | $10.39 | $2.00 | $0.60 |
| 40,001-60,000 | $15.99 | 20,000 | $0.0008 | $12.79 | $2.60 | $0.60 |
| 60,001-100,000 | $21.99 | 40,000 | $0.0005 | $17.59 | $3.20 | $1.20 |
| | $70.93 | | | $55.95 | $9.59 | $5.39 |
| Total RAS | $283.72 | | | $223.81 | $38.36 | $21.55 |

1. A method for providing promotion and advertisement of a website, comprising:
a) creating a user content based website; and
b) presenting user content and at least one advertising space on said content based website; and
c) generating returns for a service provider and the user content provider for sales of said advertising space.
